(19) United States
(12) Patent Application Publication
(10) Pub. No.: US 2002/0041086 A1
(43) Pub. Date: Apr. 11, 2002

(54) Three-dimensional passenger airbag and method

(76) Inventor: Ramesh Keshavaraj, Peachtree City, GA (US)

Correspondence Address: Milliken & Company, P.O. Box 1927, Spartanburg, SC, 29304, US

(21) Appl. No.: 09/931,461

(22) Filed: Aug. 16, 2001

Related U.S. Application Data
(60) Provisional application No. 60/226,203, filed on Aug. 18, 2000.

(51) Int. Cl. B60R 21/20

(52) U.S. Cl. 280/728.3; 280/743.1

(57) ABSTRACT

The present invention relates to a passenger airbag cushion and method, as well as an airbag module and/or an overall vehicle restraint system including the inventive airbag cushion. More particularly, the invention is directed to a three-dimensional passenger side airbag cushion for at least one of to, ¾^{th} or front mount applications. In one embodiment of the airbag has a built in mount opening similar to that of a driver airbag. In another embodiment the airbag has rod pockets for an inflator mount. In still another embodiment the airbag has a loop pocket for inflator attachment.

### CROSS-REFERENCE TO RELATED APPLICATIONS

This application claims priority to and the benefit of U.S. Provisional Patent Application serial No. 60/226,203, filed on Aug. 18, 2000, hereby incorporated by reference herein.

### FIELD OF THE INVENTION

The present invention relates to a passenger airbag or airbag cushion, and method as well as a module and/or an overall vehicle restraint system including the inventive airbag cushion.

### BACKGROUND OF THE INVENTION

All U.S. patents cited herein are hereby fully incorporated by reference.

Inflatable protective cushions used in passenger vehicles are a component of relatively complex passive restraint systems. The main elements of these systems are: an impact sensing system, an ignition system, a propellant material, an attachment device, a system enclosure, and an inflatable protective cushion. Upon sensing an impact, the propellant is ignited causing an explosive release of gases filing the cushion to a deployed state which can absorb the impact of the forward movement of a body and dissipate its energy by means of rapid venting of the gas. The entire sequence of events occurs within about 100 milliseconds. In the undeployed state, the cushion is stored in or near the steering column, the dashboard, in a door, or in the back of a front seat placing the cushion in close proximity to the person or object it is to protect.

Inflatable cushion systems commonly referred to as air bag systems have been used in the past to protect both the operator of the vehicle and passengers. Systems for the protection of the vehicle operator have typically been mounted in the steering column of the vehicle and have utilized cushion constructions directly deployable towards the driver. These driver-side cushions are typically of a relatively simple configuration in that they function over a fairly small well-defined area between the driver and the steering column. One such configuration is disclosed in U.S. Pat. No. 5,533,755 to Nelsen et al., issued Jul. 9, 1996, the teachings of which are incorporated herein by reference.

Inflatable cushions for use in the protection of passengers against frontal or side impacts must generally have a more complex configuration since the position of a vehicle passenger may not be well defined and greater distance may exist between the passenger and the surface of the vehicle against which that passenger might be thrown in the event of a collision. Prior cushions for use in such environments are disclosed in U.S. Pat. No. 5,520,416 to Bishop, issued May 28, 1996; U.S. Pat. No. 5,454,594 to Krickl issued Oct. 3, 1995; U.S. Pat. No. 5,423,273 to Hawthorn et al. issued Jun. 13, 1995; U.S. Pat. No. 5,316,337 to Yarnaji et al. issued May 31, 1994; U.S. Pat. No. 5,310,216 to Wehner et al. issued May 10, 1994; U.S. Pat. No. 5,090,729 to Watanabe issued Feb. 25, 1992; U.S. Pat. No. 5,087,071 to Wallner et al. issued Feb. 11, 1992; U.S. Pat. No. 4,944,529 to Backhaus issued Jul. 31, 1990; and U.S. Pat. No. 3,792,873 to Buchner et al. issued Feb. 19, 1974, all of which are incorporated herein by reference.

The majority of commercially used restraint cushions are formed of woven fabric materials utilizing multifilament synthetic yarns of materials such as polyester, nylon 6 or nylon 6,6 polymers. Representative fabrics for such use are disclosed in U.S. Pat. No. 4,921,735 to Bloch issued May 1, 1990; U.S. Pat. No. 5,093,163 to Krummheuer et al. issued Mar. 3, 1992; U.S. Pat. No. 5,110,666 to Menzel et al. issued May 5, 1992; U.S. Pat. No. 5,236,775 to Swoboda et al. Aug. 17, 1993; U.S. Pat. No. 5,277,230 to Sollars, Jr. issued Jan. 11, 1994; U.S. Pat. No. 5,356,680 to Krummheuer et al. Oct. 18, 1994; U.S. Pat. No. 5,477,890 to Krummheuer et al. issued Dec. 26, 1995; U.S. Pat. No. 5,508,073 to Krummheuer et al., issued Apr. 16, 1996; U.S. Pat. No. 5,503,197 to Bower et al. issued Apr. 2, 1996 and U.S. Pat. No. 5,704,402 to Bowen et al. issued Jan. 6, 1998, all of which are incorporated herein by reference.

As will be appreciated, the permeability of the cushion structure is an important factor in determining the rate of inflation and subsequent rapid deflation following the impact event. In order to control the overall permeability of the cushion, it may be desirable to use differing materials in different regions of the cushion. Thus, the use of several fabric panels in construction of the cushion may prove to be a useful design feature. The use of multiple fabric panels in the cushion structure also permits the development of relatively complex three-dimensional geometries which may be of benefit in the formation of cushions for passenger side applications wherein a full bodied cushion is desired. While the use of multiple fabric panels provides several advantages in terms of permeability manipulation and geometric design, the use of multiple fabric panels for use in passenger side restraint cushions has historically required the assembly of panels having multiple different geometries involving multiple curved seams.

As will be appreciated, an important consideration in cutting panel structures from a base material is the ability to maximize the number of panels which can be cut from a fixed area through close-packed nesting of the panels. It has been found that minimizing the number of different geometries making up panels in the cushion and using geometries with substantially straight line perimeter configurations generally permits an enhanced number of panels to be cut from the base material. The use of panels having generally straight line profiles has the added benefit of permitting the panels to be attached to one another using substantially straight seams or be substantially formed during the weaving process using a jacquard or dobby loom. Such a straight seam configuration provides a more cost-effective method of producing such airbags. The term “seam” denotes any manner or method of connecting separate fabric panels or separate portions of a single fabric panel. Thus, sewing (with thread, for example), welding (with ultrasonic stitching, for example), or weaving panels or portions together (with a jacquard or dobby loom, for example), and the like, may be employed for this purpose.

However, even with the utilization of substantially straight seams to produce airbags cushions, a problem still resides in the need for labor-intensive cutting and sewing operations for large-scale manufacture. Furthermore, since the costs of producing airbag fabrics are relatively high and there is a general need to reduce such costs, there is a consequent need to more efficiently make use of the fabric by lowering the amount which needs to be cut (cutting operations also translate into higher labor costs), reducing the amount of fabric used in order to provide substantially lower packing volumes (in order to reduce the size of the airbag modules in cars since available space on dashboards, doors, and the like, are at a premium within automobiles), and reducing the shipping weight of such products (which translates into lower shipping costs), as well as other highly desired reasons. However, it has been problematic to reduce such utilized fabric amounts in the past without consequently also reducing the available inflation airspace volume within the cushion product. There is a need then to reduce the amount of time to produce airbag cushions while simultaneously providing the lowest amount of fabric and simultaneously allow for a sufficient volume of air (gas) to inflate the target airbag cushion during an inflation event (herein described as “available inflation airspace””). Such a desired method and product has not been available, particularly for passenger-side airbags which, as noted previously require greater amount of fabric for larger volumes of air (gas) to provide the greatest amount of protection area to a passenger. With greater amounts of fabric needed, generally this has translated into the need for longer seams to connect and attach fabric panels, which in turn translates into greater amounts of time needed for sewing, and the like, operations. Furthermore, there is a need for simultaneously reducing the required amount of utilized fabric while providing sufficient volumes of available inflation airspace within the target airbag cushion. Thus, a need exists to produce high available inflation airspace volume airbag cushions with a minimal requirement in fabric utilization to manufacture the overall cushion product.

Passenger side airbags are about twice the volume of the driver side airbags because of the large space between the instrument panel or dashboard and the occupant. Unlike in trucks or SUV's, in passenger cars the windshield and the instrument panel design are such that the airbag module is usually mounted as a top mount or a ¾^{th} mount. In such situations, a two-dimensional (2D) airbag like a driver bag (driver side airbag) can not be used because a two-dimensional airbag would not provide the required excursion and coverage area. One attempt at using a two-dimensional airbag in a passenger side application by attaching a three-dimensional (3D) mouth that can be inflated is shown in FIGS. 1-3 of the drawings.

The 3D mouth formation is very cumbersome as can be seen in FIGS. 2 and 3 because of the attachment of a 3D-part to a flat fabric (2D part).

The 3D mouth is closer to the inflator and takes the inertial load of the inflator. Hence, at least 2-ply or a 3-ply fabric is used for the 3D mouth construction. In using multi-ply fabric at the mouth, the elongation or the load dissipation characteristics of the fabric is lost at the mouth area resulting in possible structural failure of the cushion at the transition from multi-ply to single-ply area. Even though the 2D-cushion portion is relatively simple to sew, the 3D mouth attachment tends to make this concept inefficient in terms of fabric usage and manufacturing.

Hence, a need exists for an improved passenger side airbag and method.

### SUMMARY OF INVENTION

In view of the foregoing, it is a general object of the present invention to provide a three-dimensional passenger side airbag cushion and method.

It is another object of the present invention to provide a cost-effective, easy to manufacture airbag cushion for utilization within a vehicle restraint system. The term “vehicle restraint system” is intended to mean both inflatable occupant restraining cushion and the mechanical and chemical components (such as the inflation means, ignition means, propellant, and the like). It is a more particular object of the present invention to provide a vehicle restraint system wherein the target airbag cushion preferably comprises very low amounts or weights of fabric and includes several straight seams to attach its plurality fabric components together (although as noted above, other configured seams may also be used as long the overall required effective seam usage factor is met). A further object of this invention is to provide an easy-to-assemble airbag cushion which is minimally labor-intensive to manufacture, and requires much lower fabric costs due to a substantial reduction in the overall requirement of utilized fabric amounts.

It is still a further object of this invention to provide a vehicle restraint system comprising an airbag cushion which provides the maximum amount of available inflation airspace volume simultaneously with a low length of seam (or seams) and low amount of utilized fabric necessary to manufacture the cushion. Another object of the invention is to provide a method of making a low cost airbag cushion (due to low levels of labor required to sew the component parts together and reduced amount of fabric to manufacture and cut) of simple and structurally efficient design. It is still another object of the present invention to provide a passenger side top mount or ¾^{th} mount airbag cushion.

To achieve these and other objects and in accordance with the purpose of the invention, as embodied and broadly described herein, the present invention provides an airbag cushion having at least one fabric component, wherein said airbag cushion possesses an effective fabric usage factor of less than about 0.0330 square meters per liter (sq. m/L), more preferably less than about 0.015 (sq. m/L) and a fabric weight factor of less than about 8.0 grams per liter (gm/L), more preferably less than about 3.0 (g/L). The effective fabric usage factor is derived from an effective fabric usage index which concerns (and is defined as) the quotient of the total amount of fabric utilized to manufacture the airbag cushion (measured in square meters) over the total volume of available inflation airspace within the airbag cushion (measured in liters). In order to exhibit a sufficiently low effective fabric usage factor, the amount of fabric must be very low with a correspondingly high available inflation airspace volume. The fabric weight index is the quotent of the total weight of fabric utilized in the construction of the airbag cushion and the available inflation airspace volume. Of course, this airspace volume will be the same for each factor since the measurements of the factors (seam usage, fabric usage, and fabric weight) are made for the same bag. Such an airbag cushion may comprise two or more separate fabric panels or a single panel with portions which require connection (preferably through the utilization of at least one substantially straight seam). The inventive bag is able to provide high available inflation airspace volumes due to the particular configurations of the used fabric panels or portions. The configurations permit more efficient utilization of fabric webs by cutting panels from the webs and producing less waste of unused fabric. The preferred embodiment is discussed in greater detail below.

The effective fabric usage factor (as defined within the correlating seam usage index formula, above) for the inventive airbag cushion then in square meters per liter is preferably less than about 0.0330, more preferably less than about 0.020, still more preferably less than about 0.018, even more preferably less than about 0.016, yet more preferably lower than about 0.014, and most preferably lower than about 0.012 (m/L). Thus, the volume of available inflation airspace within the airbag cushion should be as great as possible with the amount of fabric utilized reduced to its absolute minimum while still providing sufficient protection to a passenger in an automobile during a collision event.

The effective fabric weight factor for the inventive airbag cushion in grams per liter is preferably equal to or less than about 8.0, more preferably less than about 7.0, still more preferably less than about 6.0, even more preferably less than about 5.0, yet more preferably lower than about 3.0 (gm/L). It is preferred that the available inflation airspace within the cushion be sufficient to provide protection to an occupant during a collision event, while minimizing the weight of fabric utilized to provide the given inflation airspace.

A driver-side airbag will generally comprise a low amount of utilized fabric but also does not provide a correlative high volume of available airspace; and the prior art passenger-side airbags require large amount of fabric. Although the available inflation airspace volume in such passenger-side airbags is rather large, the total amount of utilized fabric is too large to meet the aforementioned preferred effective fabric usage or weight factors within that index. The inventive cushion therefore is relatively easy to manufacture, requires very low sewing, or similar type, attachment operations of its fabric panel components, requires low amounts of or weight of fabric, but is also configured to provide an optimum large amount of available inflation airspace for maximum protection to a passenger during a collision event.

Additional objects and advantages of the invention will be set forth in part in the description which follows, and in part will be obvious from the description, or may be learned by practice for the invention. It is to be understood that both the foregoing general description and the following detailed description of preferred embodiments are exemplary and explanatory only, and are not to be viewed as in any way restricting the scope of the invention as set forth in the claims.

### BRIEF DESCRIPTION OF THE DRAWINGS

The accompanying drawings, which are incorporated in and constitute a part of this specification, illustrate several potentially preferred embodiments of the invention and together with the description serve to explain the principles of the invention wherein:

FIG. 1 is a perspective view illustration of a two-dimensional passenger side airbag having a three-dimensional mouth.

FIG. 2 is a side view representation of the airbag of FIG. 1.

FIG. 3 is an enlarged fragmentary view of a portion of the airbag of FIG. 2.

FIG. 4 is top view illustration of the panels, sections or pieces of one embodiment of the three-dimensional airbag of the present invention.

FIG. 5 is a top view illustration of a fabric layout for six three-dimensional airbags of FIG. 4 in accordance with the present invention.

FIG. 6 is a photographic representation of a deployed three-dimensional airbag of FIG. 4 in accordance with the present invention.

FIG. 7 is a cut-away side view of a vehicle for transporting an occupant illustrating the deployment of a first inflatable restraint cushion within a vehicle restraint system.

FIG. 8 is a cut away side view of a vehicle for transporting an occupant illustrating the deployment of a second inflatable restraint cushion within a vehicle restraint system.

FIG. 9 is a cut-away view of a vehicle for transporting an occupant illustrating the deployment of a third inflatable restraint cushion within a vehicle restraint system.

FIG. 10 is an aerial view of a portion of a fabric web with lines indicating the specific locations for cutting to form six separate conventional passenger airbag cushions.

FIG. 11 is a top view illustration of the panels of a three-dimensional airbag in accordance with another embodiment of the present invention incorporating asymmetrical panels.

FIG. 12 is a top view illustration of a fabric layout for six three-dimensional airbags in accordance with the embodiment of FIG. 11.

FIG. 13 is a representation of a particular example of the panels of the three-dimensional airbag of FIG. 4.

FIG. 14 is an illustration of a particular example of the panels of the three-dimensional airbag FIG. 11.

FIG. 15 is a top view representation of the panels or pieces of another embodiment of the three-dimensional airbag in accordance with the present invention with rod pockets.

FIG. 16 is a top view representation of the panels or pieces of still another embodiment of the three-dimensional airbag in accordance with the present invention with a loop pocket for an inflator.

FIGS. 17A-17G are schematic side view representations of the transition of the 3D airbag of the present invention during deployment.

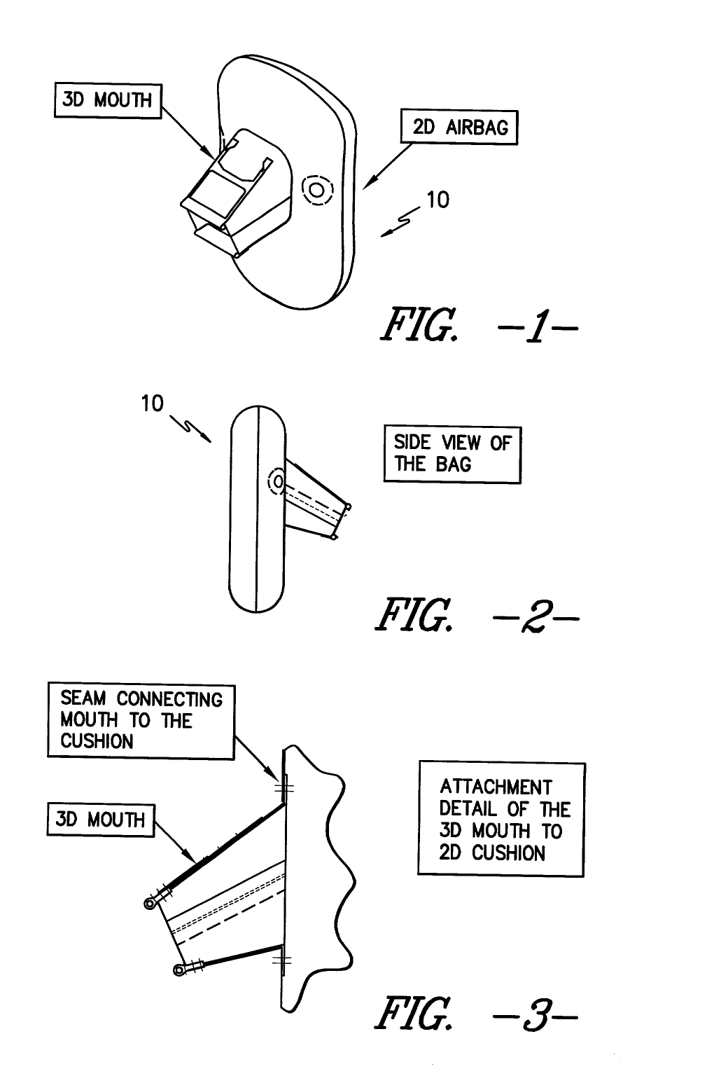

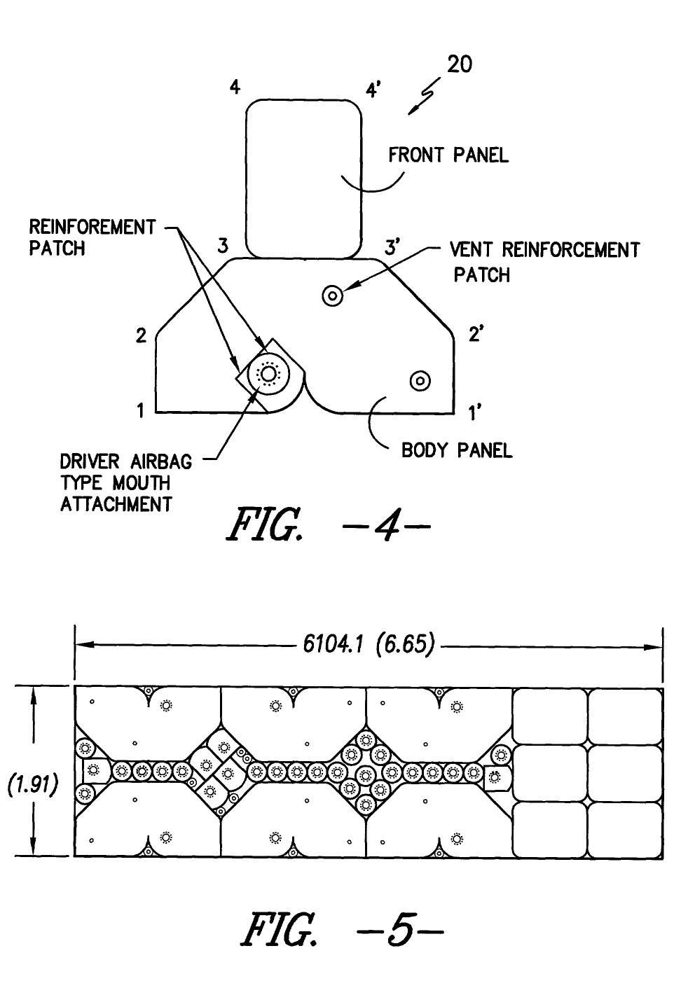

### DESCRIPTION OF THE PREFERRED EMBODIMENTS

Reference will now be made in detail to potentially preferred embodiments of the invention, examples of which have been illustrated in the accompanying drawings. It is to be understood that it is in no way intended to limit the invention to such illustrated and described embodiments. On the contrary, it is intended to cover all alternatives, modifications and equivalents as may be included within the true spirit and scope of the invention as defined by the appended claims and equivalents thereto.

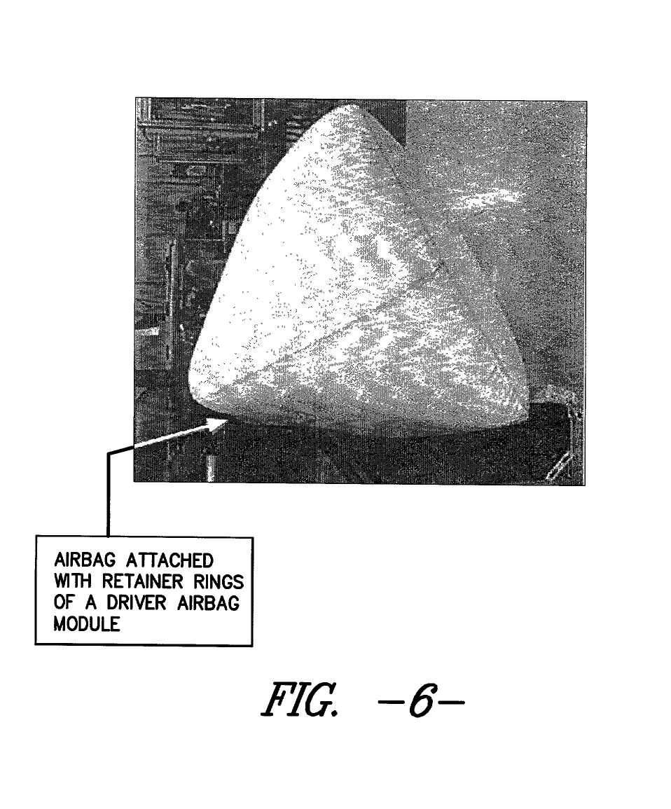

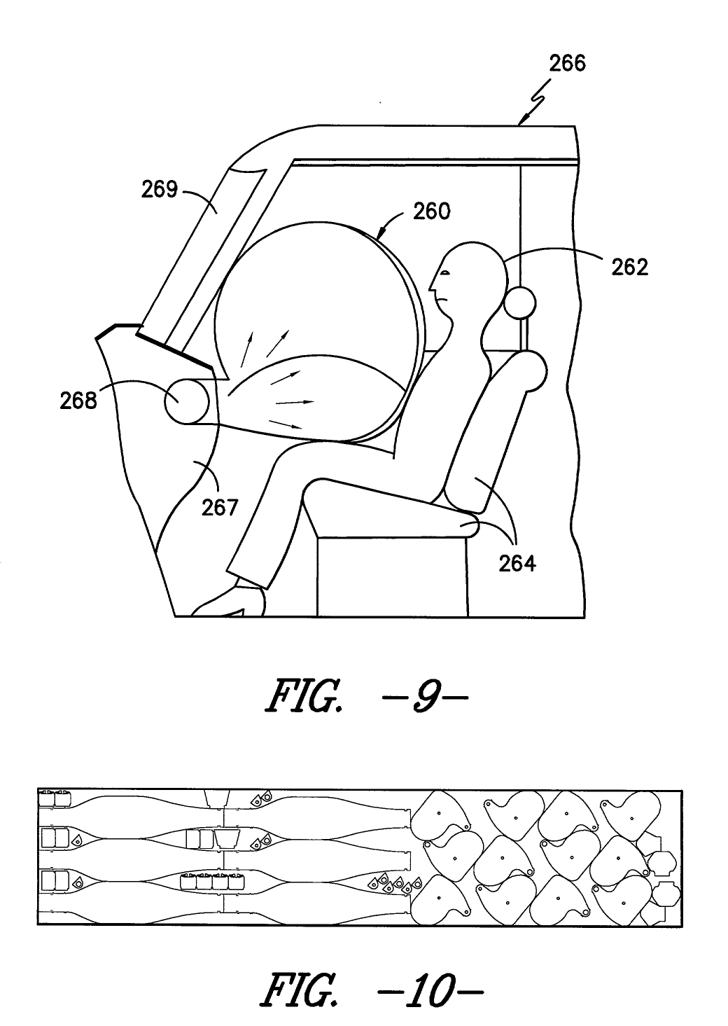

With reference to FIGS. 4-6 and 8 and in accordance with one embodiment of the present invention, the above shortcomings of the 2D passenger side cushion is addressed or overcome by using a three-dimensional (3D) bag 20 with at least one flat mouth opening similar to that of a driver airbag and which can use a retainer ring for attaching the airbag, rod pockets, a loop pocket, or the like. The airbag of the present invention is three-dimensional like current passenger airbags (FIG. 10) with required depth, but is as simple to sew as a driver airbag. A schematic of the proposed novel approach to a top mount bag is shown in FIGS. 4-6 and 8.

The design of the present invention preferably has two distinct parts, panels or panel sections (made up of one or more panels) labeled as the body panel and front panel(FIG. 4). Although it is preferred that the body panel and front panel each be a single piece, it is contemplated that one or both may be a panel section made up of two or more panels, or that they may be cut as one piece. This particular 3D airbag of the present invention uses a simple flat mouth attachment like a driver airbag type mouth. Hence, this passenger airbag can be attached to the module through a simple and cost-effective retainer ring like attachment as used on a driver airbag.

Bag manufacturing of the 3D airbag 20 of the present invention involves the following simple steps (see FIG. 4):

1. Align reinforcement patches across the mouth and vents using the pre-cut alignment holes and sew the seam to secure the reinforcements.

2. Fold the body panel in half across (0,0) and sew the seam connecting 1,1′,O

3. Attach front panel to connecting (2,3) to (3,4) and (2′,3′) to (3′,4′).

A cut part layout of six bags 20 of the present airbag design is shown in FIG. 5. As can be seen in the FIG. 5 cutting scheme, fabric utilization is well above 90% or greater.

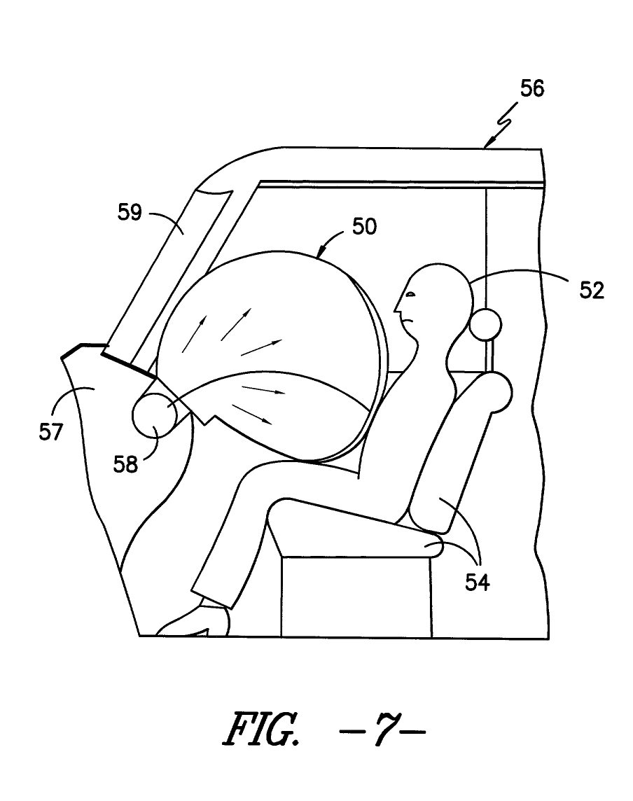

FIG. 6 shows the inflated shape of the present 3D airbag 20, such as a top mount bag. As can be seen the required depth of the inflated bag is easily achieved with this approach.

The present invention is directed to a low cost three-dimensional passenger cushion for top, ¾^{th}, or front module mount applications. The present bag can be cut into more than two major parts to improve fabric alignment at the cost of adding sewing or it can be cut as a single piece. The starting pieces can be of any shape, as long as the objective of inflated depth is provided in the bag.

In accordance with one embodiment, the present invention is a 3D passenger airbag with a flat airbag type mouth or mounting device and added depth for top and ¾^{th} module mount applications (FIGS. 6-8).

FIG. 7 shows a fully deployed ¾^{th} mount inflatable restraint cushion 50 of the present invention in opposing relation to an occupant 52 located on the front seat 54 of a vehicle 56 such as an automobile, airplane, and the like having a windshield 59. As shown, the cushion 50 may be outwardly deployed from the dash panel 57 through an inflation means 58 from a position opposite the occupant 52. It is to be understood, however, that the cushion 50 and/or other cushions may likewise be deployed from any other desired location in the vehicle including the steering wheel (not illustrated), the vehicle side panels (not illustrated), the floor (not illustrated), or the backrest of the front seat 54 for disposition in opposing relation to a rear passenger (not illustrated).

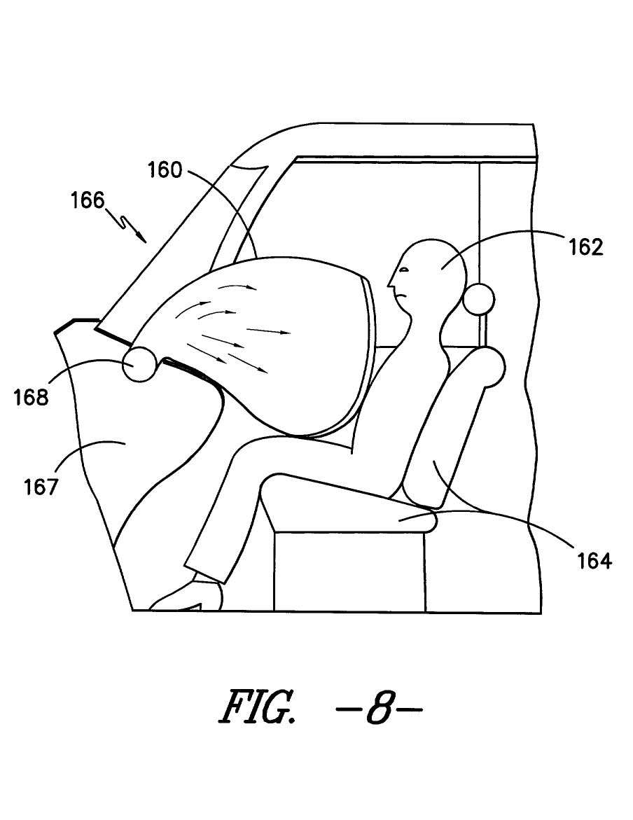

FIG. 8 shows a fully deployed top mount inflatable restraint cushion 160 of the present invention in opposing relation to an occupant 162 located in the front seat 164 of a vehicle 166 such as an automobile, airplane, and the like. As shown, the cushion 160 and/or other cushions may be outwardly deployed from the dash panel 167 through an inflation means 168 from a position opposed the occupant 162. It is to be understood, however, that the cushion 160 may likewise be deployed from any other desired location in the vehicle 166 including the steering wheel (not illustrated), the vehicle side panels (not illustrated), the floor (not illustrated), or the backrest of the front seat 164 for disposition in opposing relation to a rear passenger (not illustrated).

FIG. 9 shows a fully deployed front mount inflatable restraint cushion 260 of the present invention in opposing relation to an occupant 262 located on the front seat 264 of a vehicle 266 such as an automobile, airplane, and the like having a windshield 269. As shown, the cushion 260 may be outwardly deployed from the dash panel 267 through an inflation means 268 from a position opposite the occupant 262. It is to be understood, however, that the cushion 260 and/or other cushions may likewise be deployed from any other desired location in the vehicle 266 including the steering wheel (not illustrated), the vehicle side panels (not illustrated), the floor (not illustrated), or the backrest of the front seat 264 for disposition in opposing relation to a rear passenger (not illustrated).

The specific configurations and shapes provide low overall fabric usage as compared to the available inflation airspace volume. Each of these panels may be formed from a number of materials including by way of example only and not limitation woven fabrics, knitted fabrics, non-woven fabrics, films and combinations thereof. Woven fabrics may be preferred with woven fabrics formed of tightly woven construction such as plain or panama weave constructions being particularly preferred. Such woven fabrics may be formed from yarns of polyester, polyamides such as nylon 6 and nylon-6,6 or other suitable material as may be known to those in the skill in the art. Multifilament yarns having a relatively low denier per filament rating of not greater than about 1-6 denier per filament may be desirable for bags requiring particular good foldability.

In application, woven fabrics formed from synthetic yarns having linear densities of about 40 denier to about 1200 denier are believed to be useful in the formation of the airbag according to the present invention. Fabrics formed from yarns having linear densities of about 315 to about 840 are believed to be particularly useful, and fabrics formed from yarns having linear densities in the range of about 400 to about 650 are believed to be most useful.

While each of the panels may be formed of the same material, the panels may also be formed from differing materials and or constructions, such as, without limitation, coated or uncoated fabrics. Such fabrics may provide high permeability fabric having an air permeability of about 5 CMF per square foot or higher, preferably less than about 3 CFM per square foot or less when measured at a differential pressure of 0.5 inches of water across the fabric. Fabrics having permeabilities of about 1-3 CFM per square foot may be desirable as well. Fabrics having permeabilities below 2 CFM and preferably below 1 CFM in the uncoated state may be preferred. Such fabrics which have permeabilities below 2 CFM which permeability does not substantially increase by more than a factor of about 2 when the fabric is subjected to biaxial stresses in the range of up to about 100 pounds force may be particularly preferred. Fabrics which exhibit such characteristics which are formed by means of fluid jet weaving may be most preferred, although as noted previously, weaving on jacquard and/or dobby looms also permits seam production without the need for any further labor-intensive sewing or welding operations.

In the event that a coating is utilized on one or more material panels, neoprene, silicone urethanes or disperse polyamides may be preferred. Coatings such as dispersed polyamides having dry add on weights of about 0.6 ounces per square yard or less and more preferably about 0.4 ounces per square yard or less and most preferably about 0.3 per square yard or less may be particularly preferred so as to minimize fabric weight and enhance foldability. It is, of course, to be understood that aside from the use of coatings, different characteristics in various panels may also be achieved through the use of fabrics incorporating differing weave densities and/or finishing treatments such as calendaring as may be known to those in the skill of the art.

While the airbag cushions according to the present invention have been illustrated and described herein, it is to be understood that such cushions may also include additional components such as shape defining tethers, loops, gas vents, and the like as may be known to those in the skill of the art.

Generally, an airbag module manufacturer or automobile manufacturer will specify what dimensions and performance characteristics are needed for a specific model and make of car. Thus, airbag inflation airspace volume, front panel protection area (particularly for passenger-side airbag cushions), and sufficient overall protection for a passenger are such required specifications. In comparison with commercially available airbag cushions, the inventive airbag cushions which meet the same specifications (and actually exceed the overall passenger protection characteristics versus the prior art cushions) may require less fabric, less seam length for sewing operations, and thus cost appreciably less than those competitive cushions.

Furthermore, in standard crash tests, the inventive bags (cushions) will either perform as well as or outperform their commercially available, more expensive, counterparts.

Passenger side airbags, or airbag cushions, have primarily three modes of attachment in an automobile, namely, front ¾^{th}, and top mount. Because of the injuries caused to unbelted occupants and small occupants (5 percentile), OEM's are moving towards a top mount application. With the top mount application and a dual stage inflater, the deployment sequence is controlled in smart systems with the help of computer algorithms that determine the deployment characteristics. From the airbag design point of view, this fairly complicates the design. Now airbag designs have to be developed that will wrap around the instrument panel and have attachment below the instrument panel in such a way to angle the bag toward that occupant. This kind of attachment (because of the desired bag profile) introduces residual stress at the attachment point which is already a weak link in the system. Also, such complicated bag profiles correspond to ineffective fabric usage and increase reinforcements and sewing labor, which ultimately increases the cost.

In accordance with the one embodiment of the present invention, a new passenger airbag cushion and method is provided which allows for the existing attributes of the driver side mount and a passenger side airbag which can provide a top mount profile as shown in FIG. 8 of the drawings.

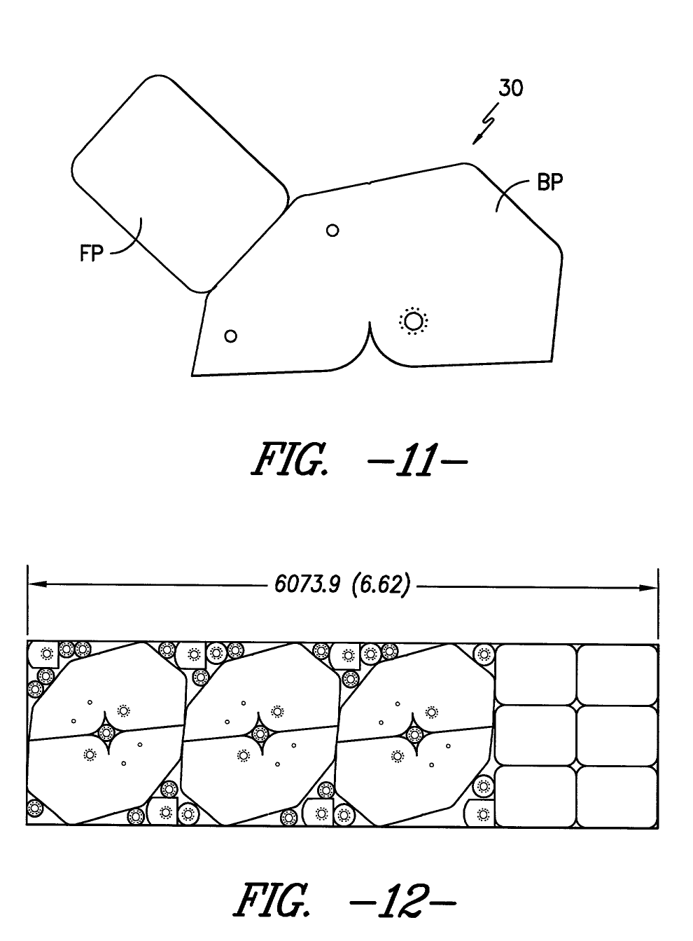

With reference to FIGS. 5 and 12 of the drawings, improved passenger bags are shown with fabric utilization in the 90% or greater range. FIG. 10 of the drawings shows a conventional approach to top mount passenger side airbags. Fabric utilization is reduced to less than 80% in the conventional layout shown in FIG. 10 of the drawings. Hence, in accordance with the present invention, a passenger airbag and method is proposed for top dash mount application without any tradeoff in fabric utilization and the like.

In accordance with a particular example of the present invention, the fabric layout of FIG. 5 has an overall length of about 6.65 yards and a width of about 1.91 yards and provides fabric for 6 passenger bags (each having an effective fabric usage factor of about 0.0136, a weight factor of about 3.294 and a 130 liter inflation volume).

With reference to FIGS. 11 and 12 of the drawings, and in accordance with another embodiment of the present invention, a three-dimensional airbag 30 with added depth for a top or ¾^{th} mount application and adapted for use with a flat type mouth mounting device includes asymmetrical body panel (BP) and a substantially rectangular front panel (FP).

With reference again to FIG. 12 of the drawings, a fabric layout for 6 passenger bags has an overall length of about 6.62 yards (with each bag having an effective usage factor of about 0.0127, a weight factor of about 3.27 and a 130 liter inflation volume).

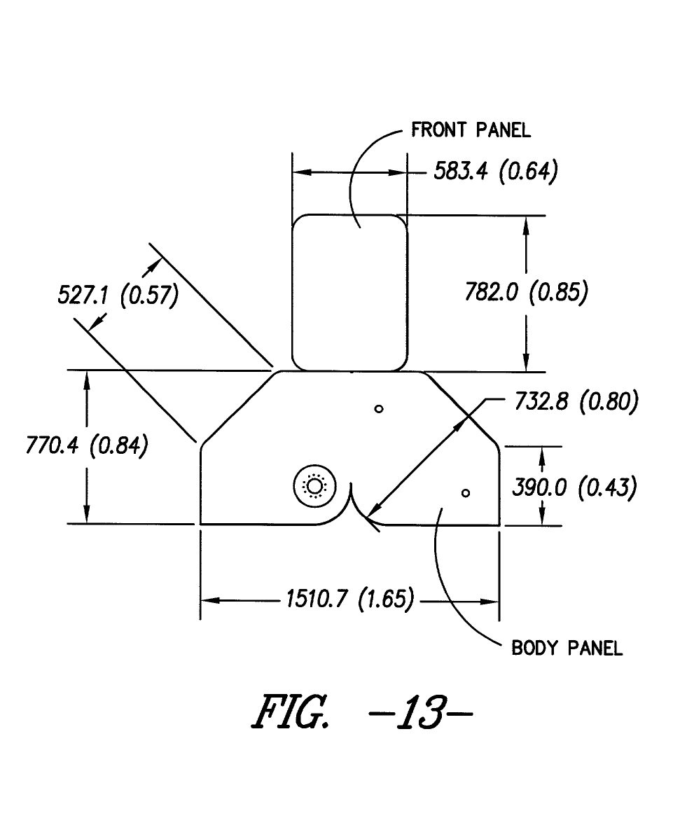

FIGS. 13 and 14 show particular passenger bag examples of the present invention with dimensions given in millimeters (mm) and in yards in brackets.

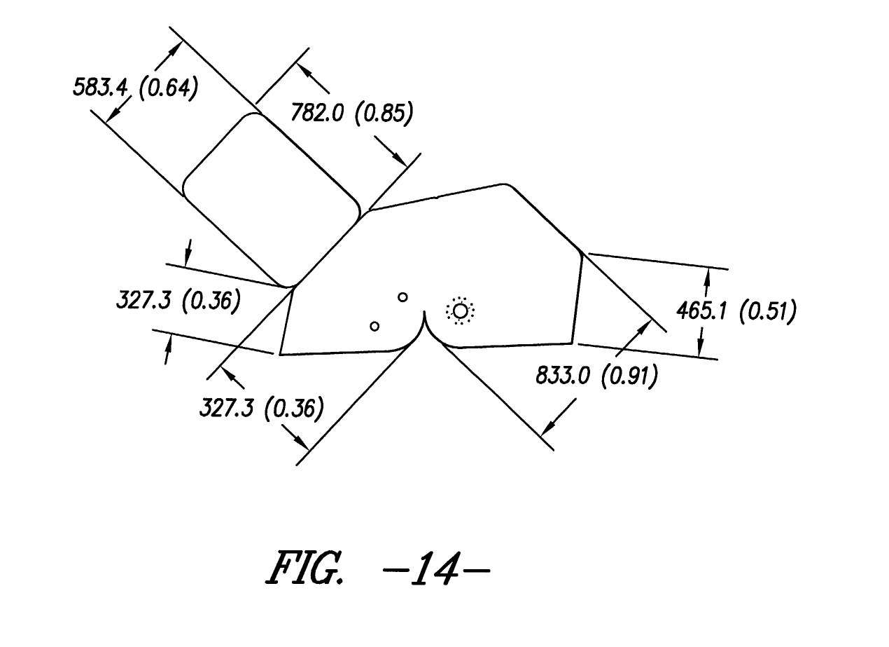

With reference to FIGS. 15 and 16 of the drawings in accordance with alternative embodiments of the present invention, although it is preferred to use, for example, a typical driver's side mouth such as shown in FIGS. 4 and 11 of the drawings, alternative three-dimensional passenger side airbags 35 and 40 are shown to include, respectively, plastic rods for bag attachment and a loop pocket for an inflator. The front panel and body panel of the airbags 35 and 40 of FIGS. 15 and 16 are similar to the panels of airbag 20 of FIG. 4.

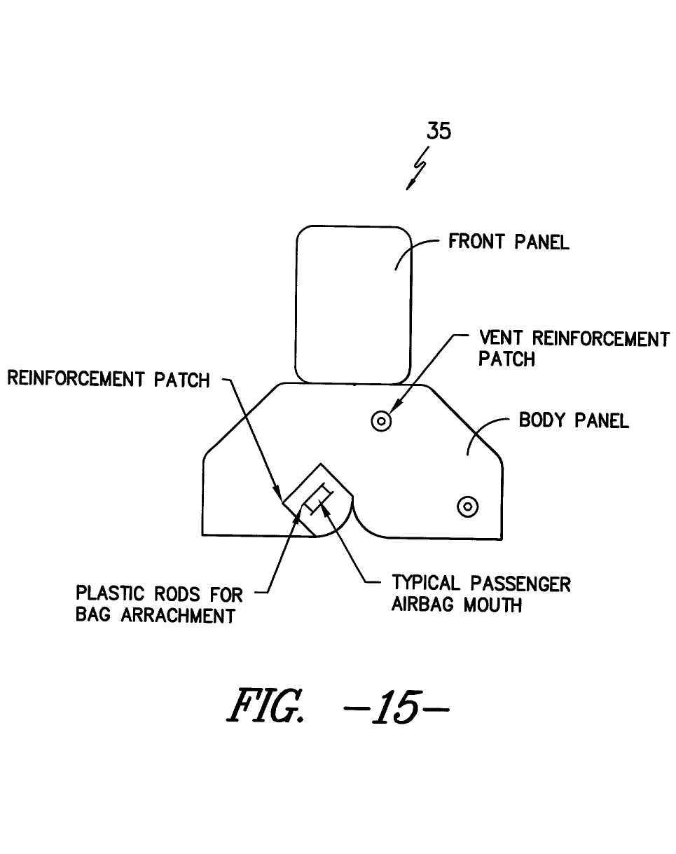

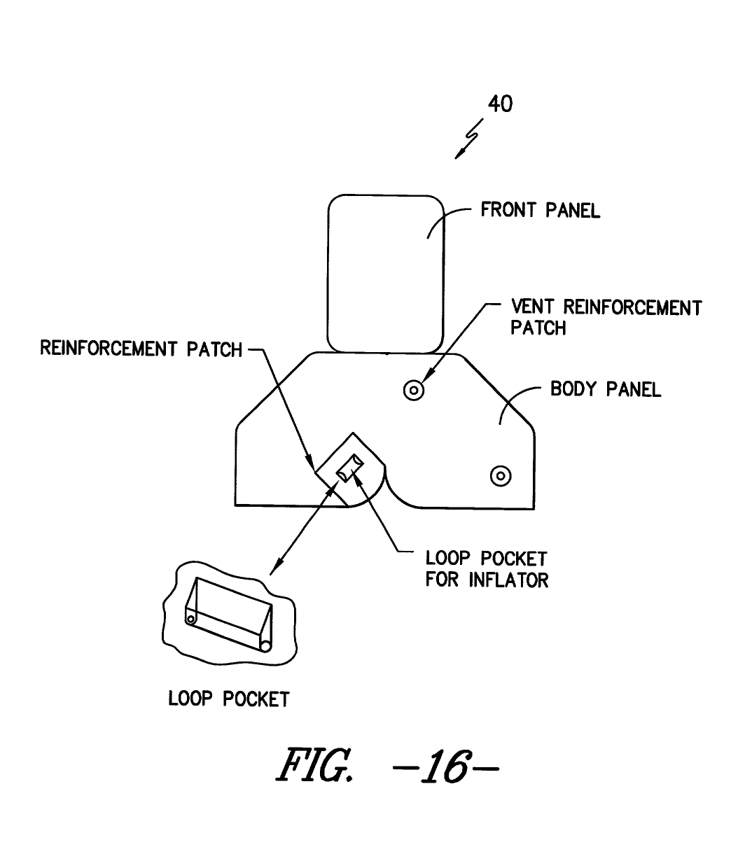

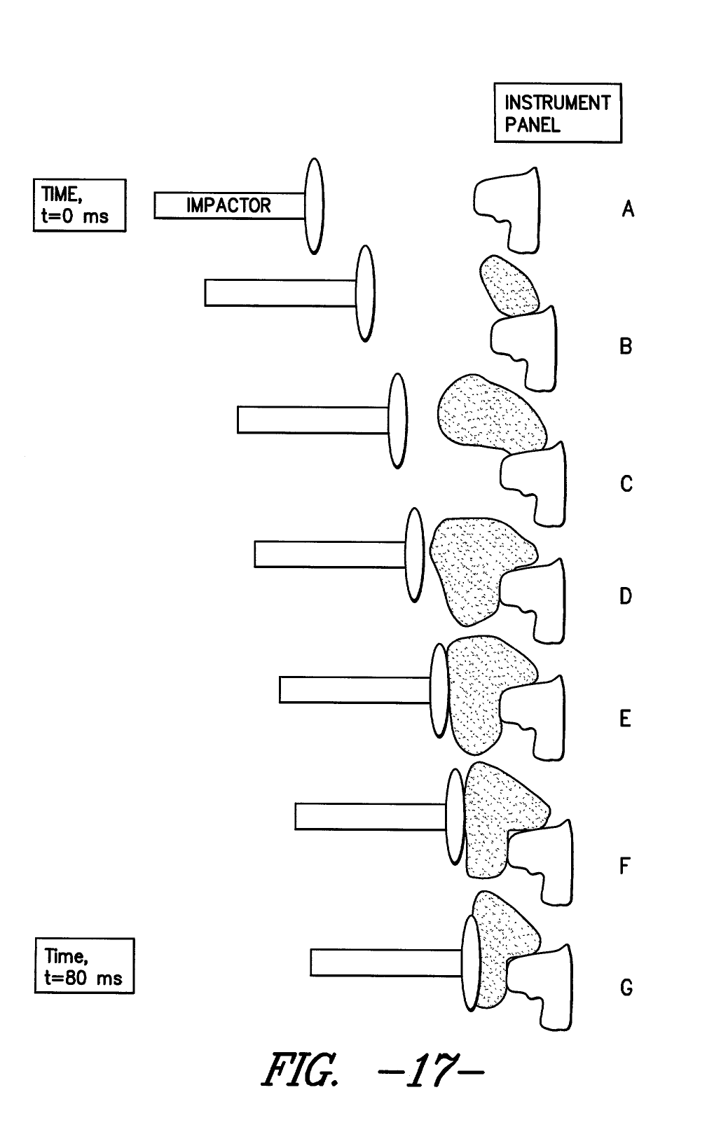

With reference to FIGS. 17A-17G of the drawings, the transition of deployment, transition during deployment, or deployment stages of a top mount three-dimensional passenger side airbag of the present invention is shown with the impactor representing a human body or occupant. As is clear from the figures, the three dimensional airbag of the present invention provides more than adequate protection for the occupant and protects the occupant from contacting the dashboard, windshield, and the like.

With reference to FIGS. 17A-17D, it is preferred that the airbag reach full deployment in about 40 milliseconds (ms), more preferably about 30 ms or less.

While specific embodiments of the invention have been illustrated and described, it is to be understood that the invention is not limited thereto, since modifications may certainly be made and other embodiments of the principals of this invention will no doubt occur to those skilled in the art. For example, the location of the mouth attachment and/or vent holes may be altered within the scope of the invention. Therefore, it is contemplated by the appended claims to cover any such modifications and other embodiments as incorporate the features of this invention which in the true spirit and scope of the claims hereto.

What I claim is:

1. A three-dimensional top, ¾^{th}, or front mount passenger airbag cushion comprising at least one fabric component, wherein said airbag cushion possesses an effective fabric usage factor of less than about 0.0330 sq. m/L.

2. The three-dimensional passenger airbag cushion of claim 1 wherein said airbag cushion possesses an effective fabric usage factor of less than about 0.020 sq. m/L.

3. The three-dimensional passenger airbag cushion of claim 2 wherein said airbag cushion possesses an effective fabric usage factor of less than about 0.018 sq. m/L.

4. The three-dimensional passenger airbag cushion of claim 3 wherein said airbag cushion possesses an effective fabric usage factor of less than about 0.016 sq. m/L.

5. The three-dimensional passenger airbag cushion of claim 4 wherein said airbag cushion possesses an effective fabric usage factor of less than about 0.013 sq. m/L.

6. The three-dimensional passenger airbag cushion of claim 1 further comprising a flat mouth inflator mount configuration.

7. The three-dimensional passenger airbag cushion of claim 1 wherein said airbag cushion comprises at least two fabric components connected by at least one seam.

8. The three-dimensional passenger airbag cushion of claim 2 wherein said airbag cushion comprises at least two fabric components connected by at least one seam.

9. The three-dimensional passenger airbag cushion of claim 3 wherein said airbag cushion comprises at least two fabric components connected by at least one seam.

10. The three-dimensional passenger airbag cushion of claim 4 wherein said airbag cushion comprises at least two fabric components connected by at least one seam.

11. The three-dimensional passenger airbag cushion of claim 5 wherein said airbag cushion comprises at least two fabric components connected by at least one seam.

12. The three-dimensional passenger airbag cushion of claim 1, further comprising rod pockets for inflator mount.

13. The three-dimensional passenger airbag cushion of claim 2, further comprising rod pockets for inflator mount.

14. The three-dimensional passenger airbag cushion of claim 3, further comprising a rod pockets for inflator mount.

15. The three-dimensional passenger airbag cushion of claim 4, further comprising rod pockets for inflator mount.

16. The three-dimensional passenger airbag cushion of claim 5, further comprising rod pockets for inflator mount.

17. The three-dimensional passenger airbag cushion of claim 1, further comprising a loop pocket for inflator attachment.

18. The three-dimensional passenger airbag cushion of claim 2, further comprising a loop pocket for inflator attachment.

19. The three-dimensional passenger airbag cushion of claim 3, further comprising a flat mouth for inflator attachment.

20. The three-dimensional passenger airbag cushion of claim 4, further comprising a flat mouth for inflator attachment.

21. The three-dimensional passenger airbag cushion of claim 5, further comprising a flat mouth for inflator attachment.

22. The three-dimensional passenger airbag cushion of claim 2, further comprising a flat mouth for inflator attachment.

23. The three-dimensional passenger airbag cushion of claim 3, further comprising a flat mouth for inflator attachment.

24. The three-dimensional passenger airbag cushion of claim 4, further comprising a flat mouth for inflator attachment.

25. The three-dimensional passenger airbag cushion of claim 5, further comprising a flat mouth for inflator attachment.

26. In a vehicle restraint system, the improvement comprising the airbag cushion of claim 1.

27. An airbag module, the improvement comprising the airbag cushion of claim 2.

28. In a vehicle restraint system, the improvement comprising the airbag cushion of claim 3.

29. In a vehicle restraint system, the improvement comprising the airbag cushion of claim 4.

30. In a vehicle restraint system, the improvement comprising the airbag cushion of claim 5.

31. In a vehicle restraint system, the improvement comprising the airbag cushion of claim 6.

32. In a vehicle restraint system, the improvement comprising the airbag cushion of claim 7.

33. In an airbag module, the improvement comprising the airbag cushion of claim 1.

34. In an airbag module, the improvement comprising the airbag cushion of claim 2.

35. In an airbag module, the improvement comprising the airbag cushion of claim 3.

36. In an airbag module, the improvement comprising the airbag cushion of claim 4.

37. In an airbag module, the improvement comprising the airbag cushion of claim 5.

38. In an airbag module, the improvement comprising the airbag cushion of claim 6.

39. In an airbag module, the improvement comprising the airbag cushion of claim 7.

40. In a method of forming a passenger side airbag cushion, the improvement comprising the steps of forming a flat mouth for inflator mount on a three-dimensional passenger side airbag.

41. A three-dimensional passenger airbag with a flat mouth for inflator mounting and added depth for top and ¾^{th} module mount applications.

42. A three-dimensional airbag having panels as shown in at least one of FIGS. 4, 11, 15, and 16 of the drawings.

43. A three-dimensional passenger airbag having a fabric weight factor of less than about 8.0 gm/L.

44. The three-dimensional passenger airbag of claim 19 having a fabric weight factor of less than about 7.0 gm/L.

45. The three-dimensional passenger airbag of claim 19 having a fabric weight factor of less than about 6.0 gm/L.

46. The three-dimensional passenger airbag of claim 19 having a fabric weight factor of less than about 5.0 gm/L.

47. The three-dimensional passenger airbag of claim 19 having a fabric weight factor of less than about 4.0 gm/L.

48. The three-dimensional passenger airbag of claim 19 having a fabric weight factor of less than about 3.0 gm/L.

49. A three dimensional airbag having a distinct shaped body panel adapted to form a conical structure, and a front panel adapted to be mated to said conical structure form a three dimensional structure.

50. A three dimensional airbag having a distinctly shaped multiple panels adapted to form a conical structure, and one or more front panels adapted to be mated to said conical structure to form a three dimensional structure.

51. The airbag of at least one of claims 1, 41, 42, 43, 49, and 50, further comprising a means for attaching an inflator.

52. The airbag of at least one of claims 1, 41, 42, 43, 49, and 50, further comprising a means for attaching an inflator.

53. The airbag of at least one of claims 1, 41, 42, 43, 49, and 50, further comprising substantially straight seams for completing the bag structure.

54. The airbag of at least one of claims 1, 41, 42, 43, 49, and 50, further comprising at least one seam on the side of the bag structure.

55. The airbag of at least one of claims 1, 41, 42, 43, 49, and 50, further comprising at least one seam on the top portion of the bag structure towards the windshield of vehicle.

56. The airbag of at least one of claims 1, 41, 42, 43, 49, and 50, further comprising at least one seam on the bottom portion of the bag structure.

57. The airbag of at least one of claims 1, 41, 42, 43, 49, and 50, further reaches the fully inflated state during deployment in under 45 milliseconds.

58. An inflatable, three-dimensional, top, ¾^{th}, or front mount passenger airbag cushion, comprising:
a body panel section having at least one panel,
a front panel section having at least one panel, said body panel section having first and second base portions being joined together along at least a first seam to form an inflation pocket,
said front panel section being mated to and enclosing said pocket, and wherein at least one of said base portions includes means for receiving an inflation medium.

59. The airbag of claim 58, wherein said body panel section has a generally truncated pyramidal configuration with a base segment of a first length,
an apex segment of a second length,
and wherein said first length is greater than said second length.

60. The airbag of claim 59, wherein said body panel section having a generally truncated pyramidal configuration further includes respective side segments.

61. The airbag of claim 60, wherein said side segments are substantially parallel.

62. The airbag of claim 60, wherein said front panel section is adapted to be attached to said apex segment and said side segments.

63. The airbag of claim 58, wherein said base segment includes at least one of an indentation or notch therein approximately midway between said first and second base portions.

64. The airbag of claim 58, wherein said body panel section includes at least one vent opening.

65. The airbag of claim 58, wherein one of said base portions is larger than the other.

66. The airbag of claim 65, wherein said larger base portion includes inflator mounting means.

67. The airbag of claim 58, wherein said base portions form right and left sides of said pocket.

68. The airbag of claim 58, wherein said base portions form the top and bottom of said pocket.

69. The airbag of claim 58, wherein said body panel section is asymmetrical.

70. The airbag of claim 58, wherein said front panel section is substantially rectangular.

71. The airbag of claim 70, wherein said front panel section has rounded corners.

72. The airbag of claim 58, wherein said means for receiving an inflation medium includes a flat mouth opening.

73. The airbag of claim 72, wherein said flat mouth opening is one of circular and square.

74. The airbag of claim 58, wherein said means for receiving an inflation medium includes an opening and rod pockets.

75. The airbag of claim 58, wherein said means for receiving an inflation medium includes an opening and a looped pocket.
